(19) United States
(12) Patent Application Publication
(10) Pub. No.: US 2021/0354164 A1
(43) Pub. Date: Nov. 18, 2021

(54) DECORATIVE GARDEN FOUNTAIN WITH A SPEAKER

(71) Applicant: Alpine Corporation, Los Angeles, CA (US)

(72) Inventor: Sohrab Robby Soofer, Beverly Hills, CA (US)

(21) Appl. No.: 17/323,955

(22) Filed: May 18, 2021

Related U.S. Application Data
(63) Continuation-in-part of application No. 16/988,208, filed on Aug. 7, 2020.
(60) Provisional application No. 63/026,720, filed on May 18, 2020.
(60) Provisional application No. 63/055,883, filed on Jul. 23, 2020.
(60) Provisional application No. 63/138,771, filed on Jan. 18, 2021.
(60) Provisional application No. 63/182,713, filed on Apr. 30, 2021.

(51) Int. Cl. B05B 17/08; H04R 1/02; F21V 33/00

(52) U.S. Cl. CPC B05B 17/08; F21W 2121/02; F21V 33/0056; H04R 1/028

(57) ABSTRACT

Provided is a portable decorative fountain, comprising: a) a body with one or more cavities for collection of water; b) a pump for pumping the water from the cavity in an upward direction; c) a conduit for carrying water that is pumped by the pump; and d) a speaker for playing sound; wherein the fountain can be operated with or without the speaker playing sound.

### CROSS-REFERENCE

The present application claims the benefit of US provisional patent application 63/182,713, filed on Apr. 30, 2021, application 63/138,771, filed on Jan. 18, 2021, application 63/055,883 filed on Jul. 23, 2020 and 63/026,720 filed on May 18, 2020. The present application is also a continuation-in-part of U.S. application Ser. No. 16/988,208, filed on Aug. 7, 2020.

### BACKGROUND SECTION OF THE INVENTION

Decorative garden fountains are typically placed in a garden for aesthetics. The existing decorative garden fountains have limited functionalities.

### SUMMARY SECTION OF THE INVENTION

Provided is a portable decorative fountain, comprising: a) a portable body with one or more cavities for collection of water, and one or more openings configured for passage of sound from inside of the body to outside of the body; b) a pump for pumping water from at least one of the cavities in an upward direction; c) a conduit for carrying water that is pumped by the pump; and d) a speaker for playing sound through one or more openings on the body; wherein the fountain can be operated with or without the speaker playing sound. The body can have a height of one foot to six feet, weight of 1 kg to 200 kg, and a longest width from bottom center of the housing that is between 1 foot to three feet. The fountain can be a cascading fountain with a plurality of cavities. The cavity can have a light placed under where the water collects. The lights can change in response to a different sound coming from the speaker. The speaker can be incorporated on a side of the fountain in relation to a lowest cavity where water collects. The speaker can be less than 2 feet elevated, facing outward. The speaker can be placed at top of the fountain. The further comprising a waterproof casing where the speaker is placed. There can be a cover for the casing with the openings, wherein the cover makes a portion of the body of the fountain and is visible from outside of the fountain. The housing can comprise two more rocks, one of the rocks of the housing having openings for travel of sound. The speaker can be placed behind at least one flow of water. The speaker can be placed behind two separate flows of water from two different cavities placed above the speaker.

Provided is a portable decorative fountain, comprising: a) a portable body with at least two cavities configured in a cascading fashion, and the body having one or more openings configured for passage of sound from inside of the body to outside of the body, wherein the body has a height of one foot to six feet, weight of 1 kg to 200 kg, and a longest width from bottom center of the housing that is between 1 foot to three feet; b) pump for pumping water from at least the cavity position at a lowest level in an upward direction; c) a conduit for carrying water that is pumped by the pump; and d) a speaker for playing sound through one or more openings on the body; wherein the fountain can be operated with or without the speaker playing sound. The lowest cavity (from the center of the portion of the cavity that is visible (not blocked by rocks)) can define a front of the body, and the speaker is placed on a side. The waterproof casing and cover where the speaker is placed, wherein the cover makes a portion of the body of the fountain and is visible from outside of the fountain.

Provided is a portable decorative fountain, comprising: a) a portable body with at least two cavities configured in a cascading fashion, the body having an opening; b) a pump for pumping water from at least the cavity position at a lowest level in an upward direction; c) a conduit for carrying water that is pumped by the pump; d) a speaker; e) a waterproof casing for placing the speaker inside of the body; f) a cover configured to fit over the casing and cover the opening of the body, the cover having a plurality of its own openings, the cover's openings configures to allow sound from the speaker to travel from one side of the cover to another side of the cover; wherein the fountain can be operated with or without the speaker playing sound.

### BRIEF DESCRIPTION OF THE FIGURES

FIG. 1 illustrates a cascading fountain with a speaker on its side (the speaker is illustrated in FIG. 2).

FIG. 2 illustrates a speaker placed on the side of the fountain of FIG. 1.

FIG. 3 illustrates internal electrical components of the fountain of FIG. 1.

FIG. 4 illustrates a side view of the fountain with the speaker placed on the side.

FIG. 5 illustrates a fountain where the speaker is placed on the top of the fountain.

FIG. 6 illustrates a fountain with a speaker having a grill.

FIG. 7 illustrates a waterproof casing for placement of the speaker.

FIG. 8 illustrates a casing cover with a plurality of openings for placement on the cover of FIG. 7.

FIG. 9 illustrates a cavity (pond) where water collects, with a light placed on the bottom of the pond.

FIG. 10 illustrates various electronic components of the fountain.

FIG. 11 illustrates a speaker that is placed above a pond.

FIG. 12 illustrates one embodiment of the fountain speaker.

FIG. 13 illustrates alternative networking arrangements.

FIG. 14 illustrates a fountain with a speaker placed immediately behind a cavity that fills with water.

### DETAILED DESCRIPTION OF THE INVENTION

Provided is a portable decorative fountain, comprising: a) a portable body with one or more cavities for collection of water; b) a pump for pumping water from at least one of the cavities in an upward direction; c) a conduit for carrying water that is pumped by the pump; and d) a speaker attached to the body to play sound. The speaker is typically placed inside of the body, with the body having an opening for the passage of sound.

Provided is a decorative fountain 1 with a speaker 4. The fountain 1 can have a plurality of speakers, such as 1, 2, 3, 4, or 5. The decorative fountain 1 can be suitable for placement in a garden. The decorative fountain 1 can have one or more components including a body/housing 28, a cavity 7 (in form of ponds as illustrated) for collection of water, a pump 25, and a conduit 29 for moving the water upward from the lowest positioned cavity 7 through the force generated by the pump 25.

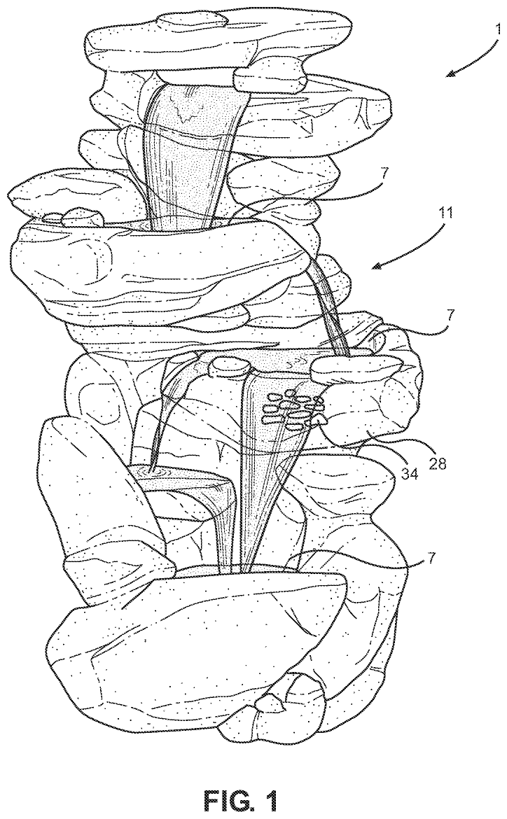

The fountain 1 can have one or more cavities 7 (ponds), such as 1, 2, 3, 4, or 5 cavities 7 for collection of water. As illustrated, the fountain 1 has three larger cavities 7 and a smaller cavity. The fountain 1 can be a cascading fountain (as illustrated in FIG. 1), where water from one pond falls into another fond that is positioned lower. Each cavity 7 (ponds), can have a light source 12 inside, which illuminates through the water in each cavity 7 (pond). The light source 12, which can be an LED (Light Emitting Diode) light, can be a single-colored light, or a multi-colored light. A transparent (waterproof) window 18 can be placed over the light source 12 on the bottom of one or more of the cavities 7 (ponds).

The speaker 4 can be placed on the bottom of the fountain 1, facing outward. The outwardly speaker 4 can be placed inside of one of the faux rocks 2 of the fountain 1. The fountain 1 can comprise two or more faux rocks 2 on the bottom, which a speaker grill 6 placed on one of the rocks 2 or openings 3 cut into the rock 2. The fountain 1 can have a housing that gives the impression of presence of plurality of rocks (such as 10 to 30 rocks), with one of the faux rocks 2 turned into a speaker 4.

The fountain 1 can also have a speaker 34 in the front, with the speaker placed behind the water that falls from one pond to another. The speaker 34 can be directly behind the waterflow, or behind and to the side of the water flow.

The fountain housing 1/28 can be made from a synthetic material such as plastic. The fountain/housing 1/28 can have a flat bottom for placement of the housing on a surface. The fountain/housing 1/28 can be one foot to four feet tall (or two feet to six feet tall) (at tallest point), and have a length and and/or width from the bottom center of the housing that is between 1 foot to three feet (at longest length). The inside of the fountain 1 can be hollow, with the rocks just representing the shape of the wall of the housing 28, and made up of a piece of plastic that looks like a rock.

The housing can have a plurality of irregularly shaped openings 3 that are configured to allow sound that is produced by the speaker 4 to travel from the inside of the housing 28 to the outside of the housing 28. The speaker 4 can be placed in a waterproof casing 16 and sealed with the casing cover 17.

The portion of the speaker 4 that produces sound (diaphragm) faces the openings 3 of the housing. The plurality of openings 3 can be spaced apart from each other in such arrangement that forms a circle. There can be about 10 to about 20 openings 3. In one embodiment, in between the housing 28 and the face of the speaker 4, optionally there can be a sealing ring, and a speaker grill 6.

In the back or side of the housing 28 there can be electronic access window 13, which can be removed to access the speaker 4, junction box 9, and power cord 8 and wire 11. A circuit board with a processor can be placed on the inside of the housing 28. The main processor 19 on the circuit board can be in electronic communication with a port, such as a USB port 22, which can be accessed from outside of the housing 28 through an opening in the cover 17. There can also be a switch for turning on and off the speaker 4 which can be accessed from outside of the housing 28. The main processor 19 can further be in communication with a processor configured for wireless communication, such as Bluetooth (Bluetooth chip) 21. In one embodiment, the fountain 1 can also have a back-up battery with or without a solar panel which only powers the speaker 4 independent of the pump 25.

FIG. 1 illustrates a cascading garden fountain 1, with the housing 28. In the cascading fountain 1 of FIG. 1, there are at least three cavities 7 (ponds) where the water collects. A pump 25 inside the fountain 1 pumps the water to the top of the fountain through conduit 29, and then the water cascades down from one cavity 7 to another. The fountain 1 of FIG. 1 is comprised of a housing 28 that gives the impression of being made from a plurality of rocks of different shapes and sizes arranged to allow for a cascading fountain with multiple cavities 7.

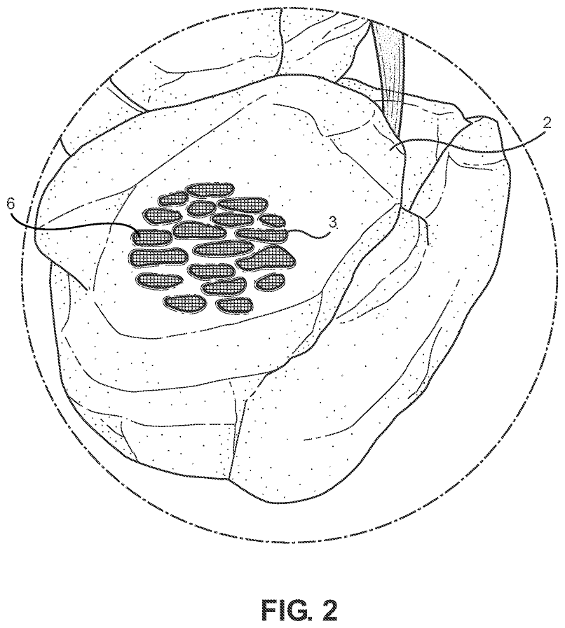

FIG. 2 illustrates placement of a speaker 4 inside of faux rock 2 of the fountain 1 on side of the fountain in relation to the front side of the fountain where the water flows. The speaker 4 is placed below two feet in height in this embodiment. As illustrated, the faux rock 2 where the speaker 4 is placed in above a smaller faux rock that sits on the ground. The speaker 4 in this embodiment is placed the side of the fountain 1 in relation to the cavity 7 where the water collects on bottom of the fountain. The grill 6 can be placed in front of speaker 4 but behind opening 3. The openings 3 are part of casing cover 17. The casing cover 17 can be blended into the body to give the impression that it is part of the body.

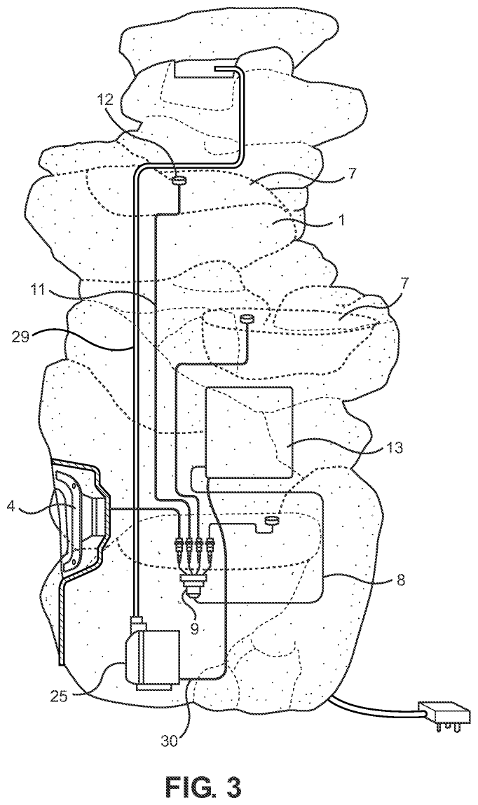

FIG. 3 illustrates the electronic components of the water fountain 1. Illustrated in this drawing is the speaker 4 placed on the side of the fountain 1. The speaker 4 is connected with a wire to the junction box 9. Additional wires 11 go to the light sources 12. A light source 12 can be placed on the bottom of each cavity 7. A power cord 8 can bring power from an outside source of energy, typically an electric plug, to power the lights. The power cord 8 can leave the fountain 1 through access window 13.

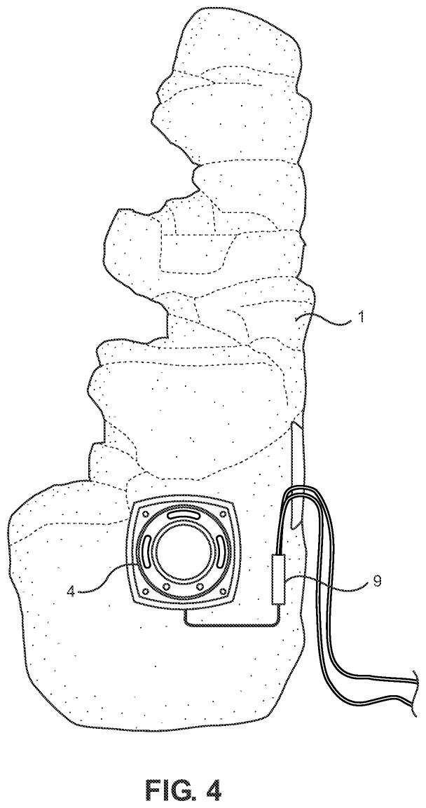

FIG. 4 illustrates a side view of the fountain 1. Illustrated in this figure is speaker 4 that is placed on the bottom side of the fountain 1 and the wiring from the speaker 4.

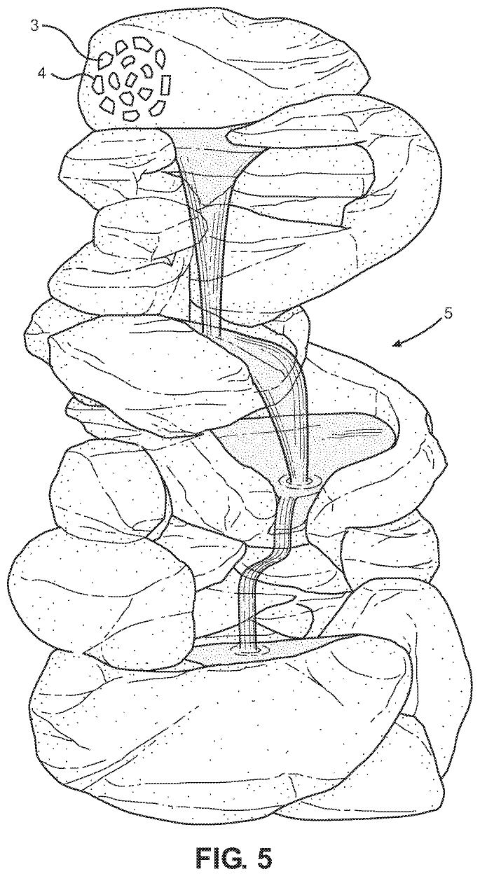

FIG. 5 illustrates fountain 1 with a speaker 4 on top of the fountain 5. The fountain 5 can be made from a plurality of rocks of different sizes, such as having the look of 10-30 faux rocks, with a speaker 4 placed inside a faux rock 2 all the way on top of the fountain 5.

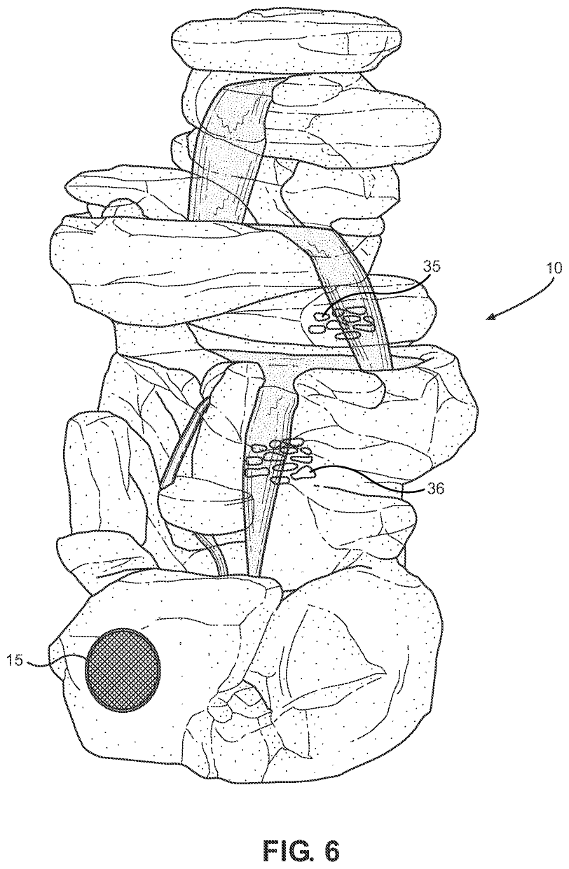

FIG. 6 illustrates the fountain 10, which is substantially the same as fountain 1 except that it uses a grill 15 instead of openings 3 in the rock 2. FIG. 6 also illustrates additional speakers 35 and 36 which can be placed in a alcove behind where water falls from one cavity to another cavity. Any of the fountains described herein can have only one speaker, or have two, or three, or even four speakers. Placement of the speaker either directly behind or behind and to the side of where water falls from one cavity to another cavity can somehow hide the speaker from view, or at least have the speaker blend in, and provide a more decorative appearance. In addition, the speaker can be placed at a higher position, somewhere in the middle of the fountain.

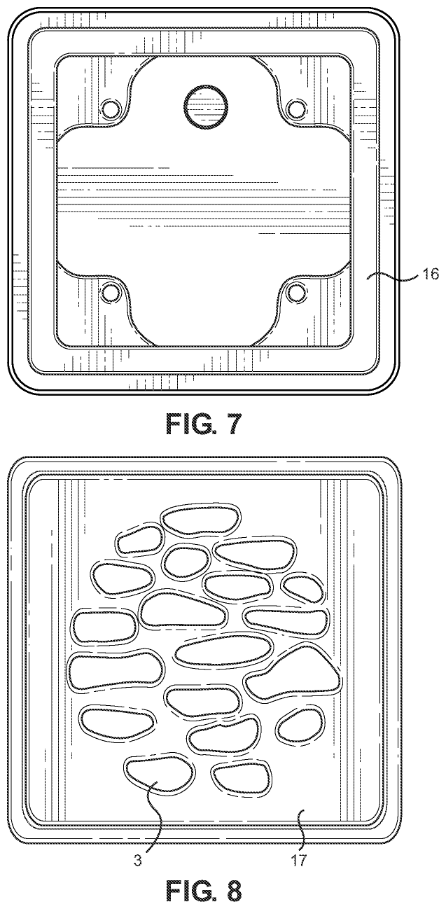

FIG. 7 illustrates a waterproof casing 16. Speaker 4 is placed inside of waterproof casing 16, which is placed inside of the faux rock 2 of the fountain 1.

FIG. 8 illustrates a casing cover 17 that is placed on the casing 16, which houses the speaker 4. Casing cover 17 has a plurality of openings 3, and forms an outer portion of the fountain housing 28. Casing cover 17 can be painted the same as the rest of the fountain 1.

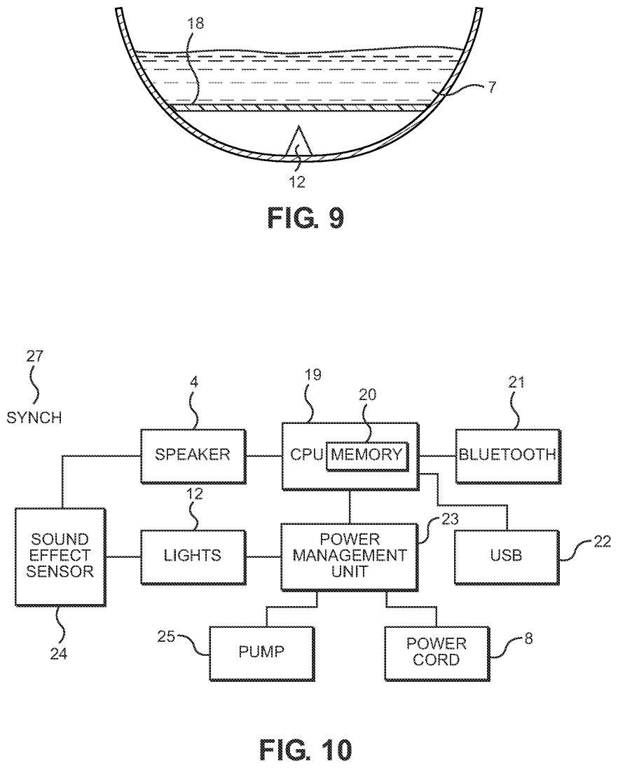

FIG. 9 illustrates a cavity 7 (pond) of the fountain 1 where the water collects. A light 12 can be placed under a transparent window 18 on the bottom of each cavity 7. Alternatively, the light 12 can be waterproof and not need a window.

FIG. 10 illustrates various electronic components of the fountains 1, such as speaker 4, CPU (Central Processing Unit) 19, memory 20, Bluetooth chip 21, light source 12, power management unit 23, USB port 22, pump 25, power exchange 26. Synchronization 27 can be between the light sources 12 and sound of the music coming from speaker

CPU (Central processor unit) 19 can be a microcontroller with internal memory 20. CPU 19 can be in communication with speaker 4 through driver. CPU 19 can also be in communication with a Power Management Unit 23 can control and monitor the electrical current. CPU 19 can also be in communication with Bluetooth chip 21 configured for wireless communication with a smart phone 33 or other electronic device of a user. The user would make a wireless communication protocol, such as by Bluetooth chip 21, to pair the speaker 4 with a user's electronic device, such as a mobile or smart phone 33, a tablet computer, or a dedicated music player. The user can then play the contents (such as songs) over the speaker 4. After receiving a wireless signal, the speaker system forms connection (pairs) with the user's device. The speaker 4 then receives audio content from the user's device. The audio content can be played as a live stream (with a minimal buffer as needed) or stored in memory 20 and played overtime.

Alternatively, a wired connection can be made with the port (such as the USB Port 22) to play the audio content (songs) and/or to charge the user's electronic device. The audio content can be uploaded from a storage device like a flash drive into the speaker's memory 20 and played over the speaker 4 overtime.

The lights 12 can be synchronized with the sound coming from the speaker 4 by using for example a sound effect sensor 24. The light 12 can change in color and/or lumens/intensity depending on the characteristics of the sound produced by the speaker 4.

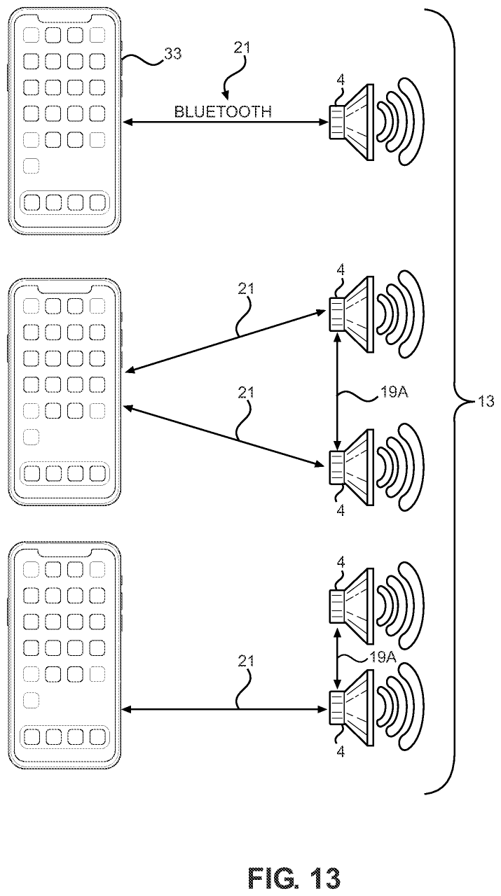

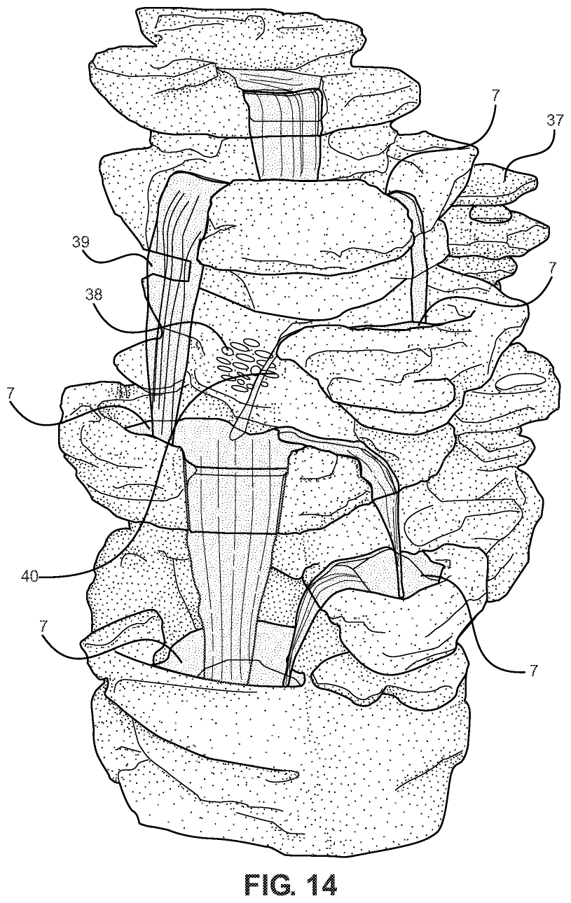

In one embodiment, a plurality of fountains play the same sound in a synchronous manner. FIG. 13 illustrates possible networking arrangements. The top arrangement illustrates a simple network with electronic device of a user (smart phone 33) and one speaker. The middle illustration shows a mesh network where each speaker is configured to communicate with the smart phone and every other speaker. The user's phone is also configured to communicate with each speaker. The bottom illustration shows one speaker acting as a master, and then communicating with all the other speakers, in this housing sending audio content to the other speakers.

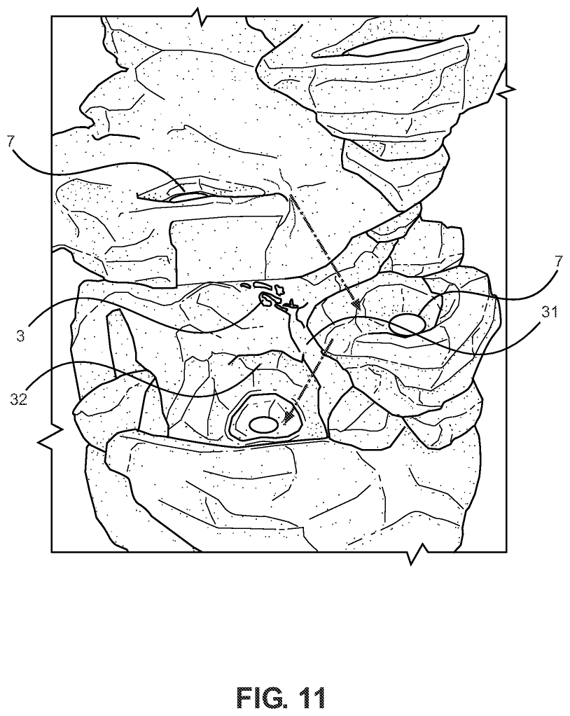

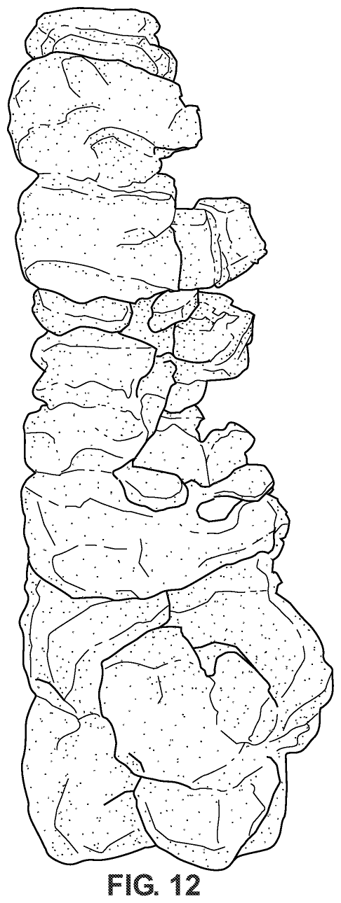

FIG. 11 illustrates a fountain where the speaker is placed on a rock above a cavity 7 that holds water, in this case, two cavities 7. The speaker openings 3 are above two cavities in this illustration. One pond immediately below the speaker openings 3 are off-set to the right, and has a channel 31 below the speaker openings that drains into a lower cavity 7. The lower cavity 7 is placed below the speaker openings. The speaker openings 3 can be placed below another cavity 7 to protect the openings from water from the above cavity. Th speaker openings 3 can be at an angle that is downwardly, such as about 1 degree to about 45 degrees. The speaker openings can be placed in a recessed position in relation to any cavity 7, such as the bottom most cavity 7. The speaker openings 3 can be inside of an alcove that is formed by placement of other cavities 7 in the fountain.

FIG. 14 illustrates a fountain with a speaker 38 placed immediately behind a cavity 7 that fills with water. In this embodiment, speaker 38 is placed immediately behind a cavity 7 that fills with water. In this embodiment, the cavity 7 that the speaker 38 is placed behind fills in with water flow 39, 40 from two separate cavities, one immediately above the speaker 38, and another that is to the side and above the speaker 38. The cavity 7 that is above the speaker 38 is a source of water for both the cavity 7 that is below the speaker 38 and the cavity 7 that is to the right and above the speaker 38. The cavities 7 immediately above and below the speaker 38 extend in front of the speaker 38 in this embodiment, with cavity before the speaker 38 extending further in the front compared to the cavity on the top, so that waster from the top cavity 7 falls into the below cavity 7. The speaker 38 can further be placed behind the cavity 7 on the side, to further block view of the speaker 38. The speaker 38 itself, placed in a cove created by the cavities 7, can have its sounds come out of one or more openings in the body, with the openings being vertical in orientation, or have an orientation that is vertical to 45 degrees. In this embodiment, a portion of the sound from speaker 38 bounces from the water in cavity 7.

### REFERENCES

1. Fountain
2. Rock
3. Openings
4. Speaker
5. Fountain with speaker on top
6. Grill
7. Cavity
8. Power cord
9. Junction box
10. Fountain with grill speaker
11. Wire to LED Light
12. Light Source (typically LED)
13. Access Window
15. Grill
16. Waterproof casing
17. Casing Cover
18. Transparent window
19. CPU
20. Memory
21. Bluetooth
22. USB port
23. Power Management Unit (PMU)
24. Sound Effect Sensor
25. Pump
26. Power Exchange
27. Synchronization
28. Body/Housing
29. Conduit
30. Power cord
31. Channel
32. Alcove
33. Smart phone
34. Openings/speaker
35. Openings/speaker
36. Openings/speaker
37. Fountain with a speaker
38. Openings/speaker
39. water flow
40. water flow

What is claimed is:

1. A portable decorative fountain, comprising:
a) a portable body with one or more cavities for collection of water;
b) a pump for pumping water from at least one of the cavities in an upward direction;
c) a conduit for carrying water that is pumped by the pump; and
d) a speaker attached to the body to play sound;
wherein the fountain is configured to be operated with or without the speaker playing sound.

2. The portable decorative fountain of claim 1, wherein the body has one or more openings for passage of sound from the speaker.

3. The portable decorative fountain of claim 1, wherein the speaker is placed inside of the body, the speaker configured to play a sound through one or more openings in the body

4. The portable decorative fountain of claim 1, wherein the fountain has a plurality of speakers.

5. The portable speaker of claim 1, wherein the opening is a single opening.

6. The portable speaker of claim 1, wherein a grill is placed over the opening.

7. The portable decorative fountain of claim 1, wherein the body has a height of one foot to six feet, weight of 1 kg to 200 kg, and a longest width from bottom center of the housing that is from 1 foot to three feet.

8. The portable decorative fountain of claim 1, wherein the fountain is a cascading fountain with a plurality of cavities.

9. The portable decorative fountain of claim 1, wherein the fountain is a cascading fountain with four to eight cavities.

10. The portable decorative fountain of claim 1, wherein the speaker is placed above at least one cavity and below at least one cavity.

11. The portable decorative fountain of claim 1, wherein the speaker is in a recessed position in the body.

12. The portable decorative fountain of claim 1, wherein the body has an alcove, the speaker placed in the alcove.

13. The portable decorative fountain of claim 1, wherein the body has an alcove, the speaker placed in the alcove behind and/or above and/or next to at least one cavity.

14. The portable decorative fountain of claim 1, wherein the speaker is placed behind at least one flow of water.

15. The portable decorative fountain of claim 1, wherein the speaker is placed behind two separate flows of water from two different cavities placed above the speaker.

16. The portable decorative fountain of claim 1, wherein at least one of the cavities has a light placed under where the water collects.

17. The portable decorative fountain of claim 1, wherein the lights change in response to a different sound coming from the speaker.

18. The portable decorative fountain of claim 1, wherein the speaker is incorporated on a side of the fountain in relation to a lowest cavity where water collects.

19. The portable decorative fountain of claim 1, wherein the speaker is less than 2 feet elevated from a ground, facing outward.

20. The portable decorative fountain of claim 1, wherein the speaker is placed at top of the fountain.

21. The portable decorative fountain of claim 1, further comprising a waterproof casing where the speaker is placed.

22. The portable decorative fountain of claim 1, further comprising a cover for the casing with the openings, wherein the cover makes a portion of the body of the fountain and is visible from outside of the fountain.

23. The portable decorative fountain of claim 1, wherein the housing comprises two more rocks, one of the rocks of the housing having one or more openings for travel of sound.

24. A portable decorative fountain, comprising:
a) a portable body with at least two cavities configured in a cascading fashion, and the body having one or more openings configured for passage of sound from inside of the body to outside of the body, wherein the body has a height of one foot to six feet, weight of 1 kg to 200 kg, and a longest width from bottom center of the housing that is between 1 foot to three feet;
b) a pump for pumping water from at least the cavity position at a lowest level in an upward direction;
c) a conduit for carrying water that is pumped by the pump; and
d) a speaker for playing sound attached to the body;
wherein the fountain can be operated with or without the speaker playing sound.

25. The portable decorative fountain of claim 24, wherein the lowest cavity defines a front of the body, and the speaker is placed on a side.

26. The portable decorative fountain of claim 24, further comprising a waterproof casing and cover where the speaker is placed, wherein the cover makes a portion of the body of the fountain and is visible from outside of the fountain.

27. The portable decorative fountain of claim 24, wherein the fountain is a cascading fountain with four to eight cavities.

28. The portable decorative fountain of claim 24, wherein the speaker is placed above at least one cavity and below at least one cavity.

29. The portable decorative fountain of claim 24, wherein the speaker is in a recessed position in the body.

30. The portable decorative fountain of claim 24, wherein the body has an alcove, the speaker placed in the alcove.

31. The portable decorative fountain of claim 24, wherein the body has an alcove, the speaker placed in the alcove behind and/or next to and/or above at least one cavity.

32. A portable decorative fountain, comprising:
a) a portable body with at least two cavities configured in a cascading fashion, the body having an opening;
b) a pump for pumping water from at least the cavity position at a lowest level in an upward direction;
c) a conduit for carrying water that is pumped by the pump;
d) a speaker;
e) a waterproof casing for placing the speaker inside of the body; and
f) a cover configured to fit over the casing and cover the opening of the body, the cover having a plurality of its own openings, the cover's openings configured to allow sound from the speaker to travel from one side of the cover to another side of the cover;
wherein the fountain can be operated with or without the speaker playing sound.
